(19) United States
(12) Patent Application Publication
(10) Pub. No.: US 2004/0036377 A1
(43) Pub. Date: Feb. 26, 2004

(54) HIGH VOLTAGE LC ELECTRIC AND MAGNETIC FIELD MOTIVATOR

(76) Inventor: Steven Mezinis, Aromas, CA (US)

Correspondence Address: STEVEN MEZINIS, 230 CARNEROS, AROMAS, CA, 95004-9717, US

(21) Appl. No.: 09/682,451

(22) Filed: Aug. 15, 2001

(51) Int. Cl. H02N 1/00

(52) U.S. Cl. 310/309

(57) ABSTRACT

An embodiment of an improved method of converting electrical energy to mechanical energy, where magnetic and electric fields are induced in a motivator comprised of a conductive magnetic mass. An induced electric charge in said mass is initiated by a charge on a conductive plate buried within said mass. Said plate is insulated by high voltage material with good dielectric properties (i.e. mica, glass, etc.). A resultant charge on said plate induces an opposite polarizing charge within each pole of said mass. A conductor that is magnetically coupled to the initiating voltage connects the poles and facilitates charge accumulation within said conductive mass. The pole faces on said mass induce opposite fields within a target. Said target's charge accumulation can be augmented by other means as well. In both cases, said target's electric charge will be attracted or repelled by the electric field in said motivator mass, producing motion (rotational, linear, vibrational, etc.). Said high voltage field generated by said plates buried within it said mass locks in said charge accumulation in and inhibits arcing. This configuration allows the use of higher voltages. Because this device can work at higher voltages, it can deliver more power.

### CROSS REFERENCE TO RELATED APPLICATIONS

This invention uses induced and applied electric and magnetic fields to convert electrical energy into mechanical energy (rotational, linear, vibrational, etc.).

### BACKGROUND OF THE INVENTION

Motors and other electromagnetic devices that convert electrical energy into mechanical energy have primarily relied on the magnetic fields to produce work such as series wound motor U.S. Pat. No. 269,281, induction motor U.S. Pat. No. 382,279, and relays U.S. Pat. No. 4,344,103. These devices ignore the more available force per unit of current present in electro-static fields. The devices that have used electro-static fields are limited to size or in power like wristwatch motors or watt meters (3,629,624, 5,965,968, or 5,726,509) and produce a small amount of work.

Furthermore, many motors that work with large charge accumulations have arcing problems due to the presence of high voltages, as would be the case in 4,225,801, 3,951,000, or 3,414,742. Field voltages necessary to produce a significant charge (and therefore increase work) must be low enough to prevent arcing or the devices must be placed in a vacuum. That means they would have all the problems that are inherent with maintaining a vacuum. One solution to this problem is to have an insulator between pole surfaces as in 735,621. This insulator increases the distance between operating poles thereby reducing effectiveness.

### SUMMARY OF INVENTION

[Objects and Advantages]

Accordingly, several objects and advantages of the present invention are

A device that uses electro-static and magnetic fields to produce a larger amount of work per unit of current than just magnetic devices alone;

A device that stores a larger electrical charge accumulation within a conductive mass and on its surfaces;

A non arcing electrostatic device capable of receiving very high voltages;

A charge accumulation induced by a high voltage field is augmented by a secondary low voltage field;

This embodiment has the secondary low voltage produced by magnetically coupling to one or both coils;

A device that induces fields that work with active or passive targets.

Still further objects and advantages will become apparent from a consideration of the ensuing description and drawings.

[Summary, Ramifications, and Scope]

Thus the reader will see that this embodiment of the motivator can deliver more power per unit of current than anything available now. Furthermore, this motivator has additional advantages in that it is flexible and can be used to produce linear, vibrational, or rotational movement. It does not have the arcing problem that other electrostatic devices have. Its power is directly proportional to the number of emitters, emitter plate voltage, and said lower polarizing voltage field. In addition, motivator and target (if necessary) would be encased in a high voltage insulation to ensure electrical integrity.

While my above description contains many specificities, these should not be construed as limitations on the scope of the invention but rather as an example of one preferred embodiment thereof. For example,

A motivator having more than 2 poles and/or be polyphase;

34 and 42 can be completely embedded in an insulation material 36 or 44 (as in glass), eliminating the need for 38 or 46;

High voltage emitters may be non-rectangular as in FIG. 6;

Any type of pole material that will work with this application;

FIG. 1 shows the electric and magnetic fields share a pole. It is possible that they can have separate dedicated poles, one magnetic (and non-conductive, i.e. ferrite) and one electric (non-magnetic and conductive, i.e. aluminum);

Separate exciter coils, one for magnetic induction on the target as in FIG. 4 and one to initiate a current flow in 22;

As in FIG. 6 embodiment, remove 16 so there is electrical continuity between poles, remove 22 from 13, rotate it ninety degrees, and place 22 inside the hollow of the C made by 10, such that the eddy currents in 10 produced by 22's magnetic field replace 26;

As in FIG. 6, split 20 into in to 2 coils, one coil serving as an exciter for 22 and while the other coil produces the magnetic field element of the motivator;

Have 10 be of uniform shape as in FIG. 6;

FIG. 6 shows the magnetic pole exciter coil and the high voltage exciter coil being in series, other arrangements can be used i.e. parallel or separate power sources together;

Add a coil and insulator similar to 26 and 16 FIGS. 3 and 4 to Option B FIG. 5, such that the induced magnetic fields on a target generate a low voltage;

Assemble 17 and 29 such that they slide out of the core material and can be replaced;

Strategically add capacitors to convert the device into a tuned circuit;

Use magnetic fields to only produce the conditions that cultivate electro-static charge accumulation.

Accordingly, the scope of the invention should be determined not by the embodiments illustrated, but by the appended claims and their legal equivalent.

### BRIEF DESCRIPTION OF DRAWINGS

FIG. 1 Illustrates the motivator minus the requisite High Voltage insulation encapsulation.

FIG. 2 Shows section I-I

FIG. 3 Shows section II-II

FIG. 4 A Schematic of FIG. 1 embodiment

FIG. 5 Target variations that show other means to induce additional target charge accumulation, plus schematics

FIG. 6 An embodiment where the low voltage is generated by eddy currents

[Reference Numbers]

10, Core
11, Gap
12, Laminated Conducting Magnetic Plates
13, Small Core
14, Motivator Pole Face
15, Large Core
16, Pole Insulator
17, Motivator Pole
18, Shorting Connector
19, Motivator
20, Primary Coil
22, High Voltage Coil
24, High Voltage Coil Insulated leads
26, Secondary Low Voltage Coil
28, Voltage Limiter (spark gap)
29, Target
30, Charge Storage Device
31, Target Pole Face
32, Target High Voltage Electric Field Emitter Assembly
33, Target Voltage Limiter
34, Target High Voltage Emitter Plates
35, Target Bleed Resistor
36, Target High Voltage Emitter Insulator
38, Target High Voltage Emitter Insulator Fill
39, Target Core Plates
40, Motivator High Voltage Electric Field Emitter Assembly
42, Motivator High Voltage Emitter Plate
43, Motivator High Voltage Emitter Lead
44, Motivator High Voltage Emitter Insulator
46, Motivator High Voltage Emitter Insulation Fill
48, High Voltage Emitter Connection Buss
50, High Voltage Lead
52, Static Electricity Source

### DETAILED DESCRIPTION

[Physical Description]

Motivator

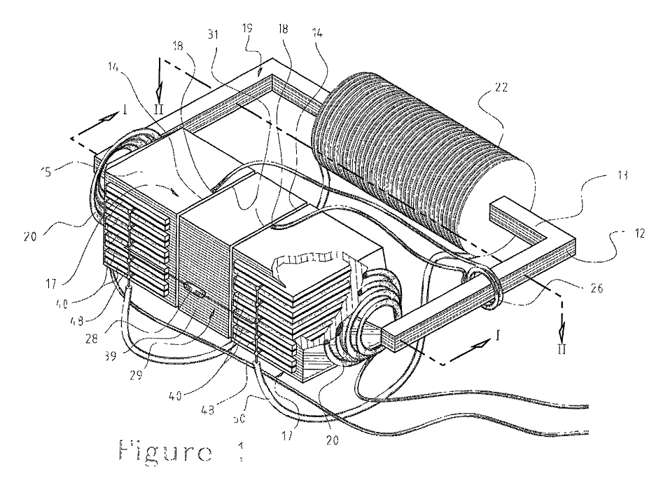

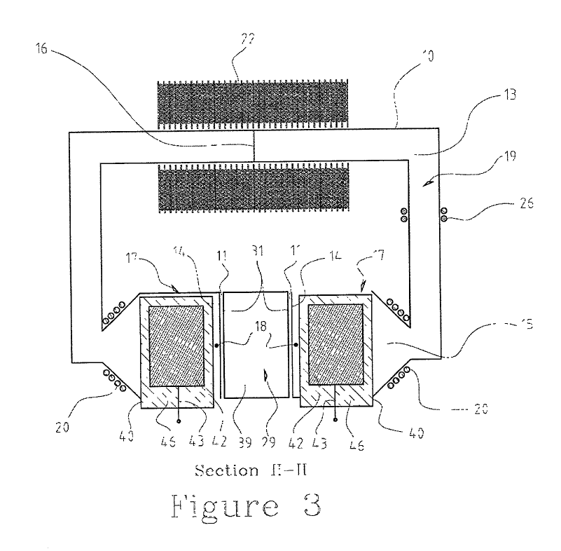

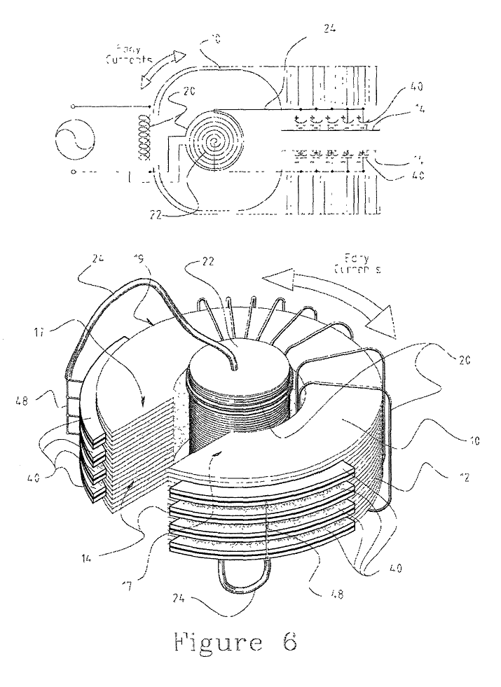

In this embodiment, the magnetic fields and electric fields share the same poles 17. Said pole's core material 10 has magnetic and conductive qualities. The core material is a conductive mass comprised of the standard laminated iron plates 12 used in common motors and transformers. Said plates are shown cut such that they make a C shape as shown in FIGS. 1, 3, and 6.

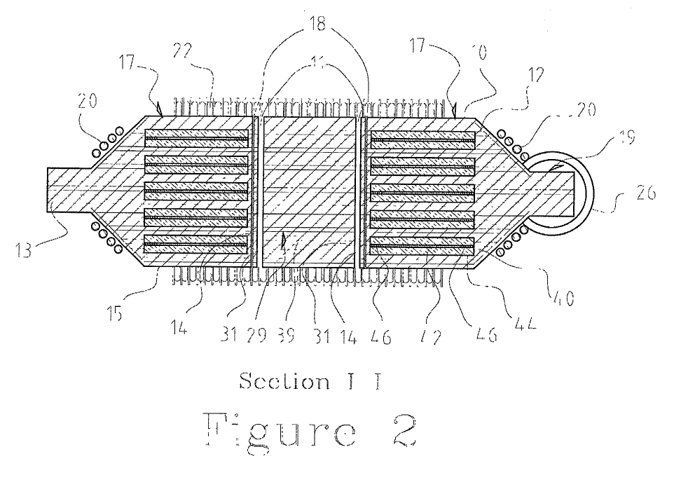

In FIGS. 1, 2, and 3, the closed side of said C is small 13 while the open side of said C is expanded large 15 to form two poles FIGS. 1, 2, +3. A low voltage insulator 16 placed in the said small part of the C and electrically separates the upper and lower halves of the C. The poles 17 and pole surfaces 14 in the open part of the C are far enough apart to allow for the target 29 and a small gap 11. Near the pole surfaces is conductive shorting device shown as rivet 18 that facilitates an electrical connection between the core plates.

In the poles of the motivator 17, is an array of high voltage field emitter assemblies 40 embedded in a coplanar manor within said core material. Between the emitters, as in FIG. 2 Section I-I is more of said core material. In this embodiment, alignment of these emitters are such that they are parallel with core plates and in such a manor that the surface charge of the emitter plates 42 have a minimal direct effect on said motivator pole surfaces. This is shown in FIGS. 1+2 as 40 being right angles to 14.

Said high voltage emitter assemblies are comprised of a foil conductor 42 sandwiched between two pieces of high voltage insulation material 44 with excellent dielectric qualities. The edges are sealed with a plastic or resin high voltage insulation material 46. Connected to the foil and emerging out of the edge of this emitter assembly is a conductor lead 43. Said emitter plates should be completely surrounded by the core material so as to minimize any direct electric field influence outside of 17 and to induce a polarization of said conductive mass. The emitter leads emerging from 15 are electrically connected together with a conductor 48.

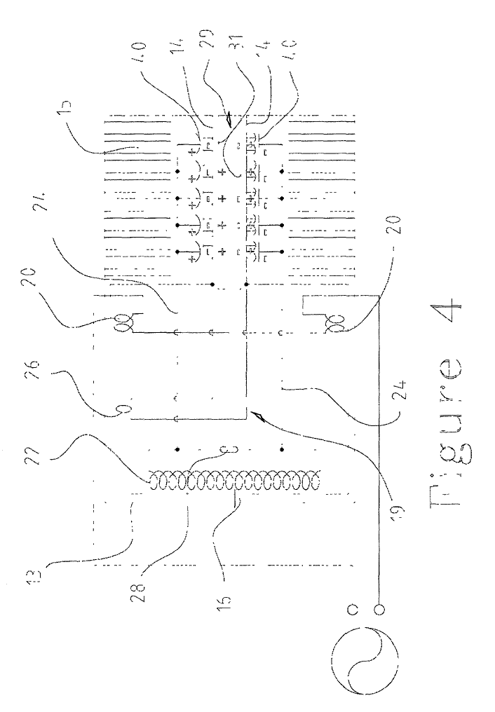

In FIGS. 1, 2, and 3, a primary winding 20 is wound around 10 and positioned so it will have a magnetic effect on the target. A high voltage secondary winding 22 is wound around said core at 13 with high voltage leads 50 connecting coil ends to 48. Across the high voltage coil is a voltage limiter 28 shown in FIG. 4 as a spark gap.

A low voltage secondary winding 26 is wound around 10 and positioned between 22 and 20; 26's coil ends are connected to shorting rivets 18. The coil connections of 22 and 26 are such that their effects on said conductive mass are 180 degrees out of phase. As said mass is being polarized by 40, 26 is assisting with the polarization.

Target (Passive)

FIG. 1 shows a target 29 as having the same laminated core material 39 as said motivator. The dimensions of motivator and target are such that there is a gap 11 between 31 and 14 to allow for electrical isolation and movement.

Target (Active)

An active target is constructed with similar materials and with similar considerations as the motivator.

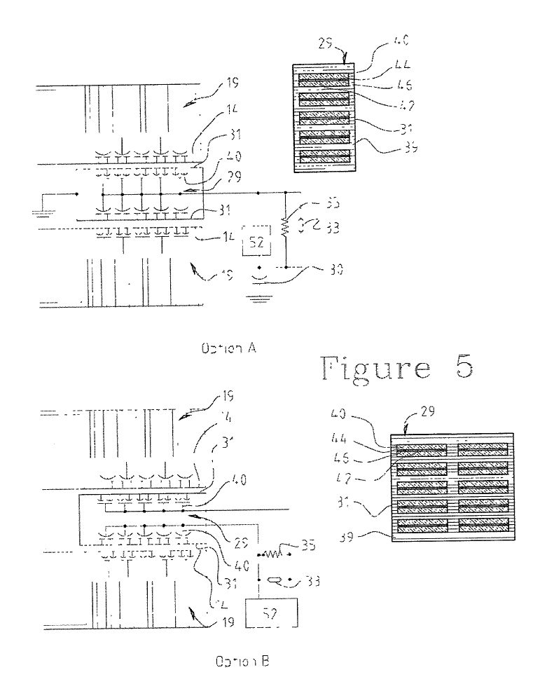

There can be target variations as shown in FIG. 5.

Option A shows one array of emitters 32 symmetrically mounted and sandwiched between conductive plates 39 similar to said motivator. This array is connected to one side of a static electricity generator 52. The other side of 52 is connected to ground through a high voltage storage device 30. Across 52 are a voltage limiter 33 and a bleed resistor 35.

Option B presents 2 arrays of emitters symmetrically mounted and sandwiched between 39 similar to 17. A static electric generator is connected between the 2 arrays such that the generated voltage is reflected in the 2 plate arrays polarizing 39. As in option A, 33 and 35 are connected across 52.

[Operation of Invention ]

Passive Target

Referring to FIGS. 1 and 4, an AC voltage is applied across 20 and a number of events occur. One is a magnetic field is generated in 15 and appears at 14. This field induces an opposite field in magnetic material of 29 and an attraction occurs between 14 and 31.

While this is happening, the same magnetic field is present in 13 and is inducing current in 22. A high voltage is generated across 22 and is conducted to the two emitter arrays in 17. Said subsequent charge and its field accumulation on 42 are transmitted through dielectric material 44, inducing an opposite charge within said conductive mass that makes up 17. Because 42 is surrounded by conductive material 12 the effect from outside the system is an apparent electrical charge accumulation polarizing said respective pole masses.

A magnetic field initially caused by 20 also affects 26, which is connected to 17 through 18. Said magnetic field induces a current at low voltage in 26 and at a voltage low enough as not to produce arcing over gap 11. Said resultant current and resultant low voltage field aids said electrical polarization. An outcome is an electric charge is induced within 17, induced and locked in by the charge on 42 and insulator 16, and is assisted by magnetically coupling of 26.

The pole surfaces 14 are affected by the charge accumulation within 17. The resultant charge on 14 induces an opposite charge on 31. This has two effects one is to cause an attraction between said poles and target and the other is the oppositely charged target pole face's field will reflect back and augments charge accumulation on 14.

Because the electric field forces are stronger and require less energy to produce than magnetic field forces, this invention would produce more work per unit of applied current.

Active Target

A static electric generator 52 is connected either by mechanical means (motion produces charge) or electrical means (a circuit is activated). Option A would accumulate an induced charge in said target suitable for vibrational motion. Option B, as with a passive target would accumulate an induced charge in said target suitable for linear and rotational motion.

With both options, as 52 is activated and a charge accumulates on 34, it induces an opposite charge in said conductive mass around it in 29. This process is similar to the charge accumulation in 17 and polarizes 29. Said accumulated charge would be attracted to or repelled by the charge held by 17 and 14, producing motion.

A bleed resistor 35 eliminates stored charge after activation is finished and 33 insures that the voltage on 34 is limited to a preset amount.

1. A device that uses electrostatic and magnetic fields to produce motion, comprising of a motivator and a target,

2. A method to induce electric and magnetic fields in said motivator and on said target,

3. A means to induce fields within said target,

4. A means to induce an electric charge within a conductive mass and thereby polarizing said mass,

5. A means of electrically polarizing said conductive mass by burying dielectrically insulated high voltage field emitters within said mass,

6. A means to assist said polarizing charge accumulation with a low voltage field (produced through either magnetically coupling or other means).

7. Whereby the fields induced in said target by said motivator (and possibly aided by other means) will be attracted and/or repelled by said motivator.
